(19) United States
(12) Patent Application Publication
(10) Pub. No.: US 2008/0201551 A1
(43) Pub. Date: Aug. 21, 2008

(54) Virtual disk router system and virtual disk access system and method therefor

(75) Inventors: Nan Zhang, Tianjin (CN); Rui Zhang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/707,875

(22) Filed: Feb. 20, 2007

(51) Int. Cl. G06F 12/10

(52) U.S. Cl. 711/203

(57) ABSTRACT

A virtual disk (VD) router system, a VD access system, and a method therefor, applied to a dual-controller system including a first controller and a second controller, are provided. First, a mapping virtual block device (VBD) corresponding to a VD of the second controller and/or the first controller is established in the first controller and/or the second controller, and a mapping relation list and a data transmission channel of the VD and the corresponding VBD thereof are established. When the first controller/the second controller issues an access request to the VD of the second controller/the first controller, the data transmission channel is used to transmit the access request to the VD and transmit the response data to the access request from the VD. Therefore, the overall access to all the VDs in the dual-controller system can be achieved.

### BACKGROUND OF THE INVENTION

1. Field of Invention

The present invention relates to a method of accessing a virtual disk (VD). More particularly, the present invention relates to a VD access system in a dual-controller system and a method therefor.

2. Related Art

Recently, in a single-controller system, all the entity disks are subordinate to one unique controller. The controller can establish a VD through redundant arrays of independent disks (RAID) and logical volume management (LVM), so as to be provided for systems or used as shared disks for customer applications such as file transfer protocol (FTP) and server message block (SMB).

However, in the dual-controller system, all the entity disks are interactively connected, i.e., respectively connected to two controllers of the system at the same time. These hard disks are not subordinate to one specific controller, and each controller can operate the entity disks through individual RAID and LVM, so as to establish a VD. However, different from the VD in the single-controller system, the VD in the dual-controller system is only subordinate to the controller establishing the same, and is invisible for the other controller. The reason is that in the dual-controller system, each controller can be considered as a relatively independent sub-system, and the RAID and LVM in each sub-system are both independent from the other sub-system. Thus, apparently, the VD established by the RAID and LVM in a sub-system is only visible in the present sub-system, while invisible for the other sub-system. Therefore, it is impossible for each controller to directly operate the VD in the other controller, and the limitation is inconvenient for the subscriber, thus affecting the data sharing, and alleviating the usability of the system.

### SUMMARY OF THE INVENTION

In order to solve the problems and disadvantages in the conventional art, the present invention is directed to provide a VD router system, so as to fulfill the process of the local controller application on the access request of the VD of the remote controller.

The present invention is also directed to provide a system capable of fulfilling the overall access to the VDs in a dual-controller system and a method therefor, such that any single-controller can directly or indirectly access all the VDs in the dual-controller system.

Thereby, the present invention discloses a VD router system applied to a dual-control system having a first controller and a second controller. The VD router system is disposed in the first controller, and comprises a virtual block device (VBD) management module, a mapping list management module, and a communication management module. Here, the VBD management module establishes a mapped VBD corresponding to the VD of the second controller in the first controller, and processes an access request of the VD issued to the first controller. The mapping list management module establishes a mapping relation list of the VD of the second controller and the corresponding VBD, and looks up the VD and the corresponding mapped VBD thereof in the mapping relation list according to the access request of the VD issued to the first controller. The communication management module is used to establish a data transmission channel of the VD of the second controller and the corresponding mapped VBD thereof.

The present invention also discloses a VD access system applied to a dual-control system having a first controller and a second controller. The VD access system comprises a first VD router disposed in the first controller, for determining the position of the VD issuing an access request to the first controller, so as to select a transmission path to transmit the access request to the VD and transmit the response data to the access request from the VD; and a second VD router disposed in the second controller, for determining the position of the VD issuing an access request to the second controller, so as to select a transmission path to transmit the access request to the VD and transmit the response data to the access request from the VD.

According to the VD access system of the present invention, the first VD router comprises a first VBD management module, a first mapping list management module, and a first communication management module. Here, the first VBD management module establishes a mapped VBD corresponding to the VD of the second controller in the first controller. The first mapping list management module establishes a mapping relation list of the VD of the second controller and the corresponding VBD thereof, and looks up the VD and the corresponding mapped VBD thereof in the mapping relation list according to the access request of the VD issued to the first controller. The first communication management module is used to establish a data transmission channel of the VD of the second controller and the corresponding mapped VBD thereof. Further, the second VD router comprises a second VBD management module, a second mapping list management module, and a second communication management module. Here, the second VBD management module establishes a mapped VBD corresponding to the VD of the first controller in the second controller. The second mapping list management module establishes a mapping relation list of the VD of the second controller and the corresponding VBD thereof, and looks up the VD and the corresponding mapped VBD thereof in the mapping relation list according to the access request of the VD issued to the second controller. The second communication management module is used to establish a data transmission channel of the VD of the first controller and the corresponding mapped VBD thereof.

Further, the present invention provides a method of accessing a VD applied to a dual-control system having a first controller and a second controller. The method comprises: establishing a mapped VBD corresponding to a VD of the second controller and/or the first controller in the first controller and/or the second controller; establishing a mapped VBD relation list of the VD of the second controller and/or the first controller and the corresponding VBD thereof; looking up the VD and the corresponding mapped VBD thereof in the mapping relation list, according to the access request of the VD issued to the first controller/the second controller, so as to determine the position of the VD; and establishing a data transmission channel of the VD and the corresponding mapped VBD thereof, when the VD issuing the access request to the first controller/the second controller is located in the second controller/the first controller.

The VD router system of the present invention establishes the mapped VBD of the VD of the remote controller and the mapping management list in the local controller, and establishes the data transmission channel between the two, thereby fulfilling the access request of the local controller to the VD of the remote controller.

Further, the VD access system of the dual-controller system of the present invention respectively disposes a VD router in each sub-system of the dual-controller system, such that any controller can directly or indirectly access all the VDs in the system. It is not necessary for the subscriber to care which sub-system the accessed VD is located in, in order to fulfill the overall access of the VDs in the dual-control system.

The method of accessing the VD of the dual-controller system according to the present invention respectively establishes the mapped VBD of the VD and the mapping relation list thereof in two sub-systems, and establishes the data transmission channel of the two, thereby fulfilling the overall access of the VDs in the dual-controller system, and improving the usability of the system and the flexibility of the disk access.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a system block diagram of the structure of a VD access system according to the present invention;

FIG. 2 is a diagram of the operating principle on establishing the mapped VBD of the VD access system according to the present invention;

FIG. 3 is a diagram of the corresponding relations between the VDs and the mapped VBDs in the first controller and the second controller;

FIG. 4 is a diagram of the operating principle on accessing the VD of the VD access system according to the present invention;

FIG. 5 is a flow chart of the process of the method of accessing the VD according to the present invention;

FIG. 6 is a flow chart of processing the access request of the VD in the method of accessing the VD according to the present invention; and

FIG. 7 is a flow chart of the process of the data transmission of the mapped VBD in the method of accessing the VD according to the present invention.

### DETAILED DESCRIPTION OF THE INVENTION

The features and practice of the preferred embodiments of the present invention will be illustrated in detail below with the accompanying drawings.

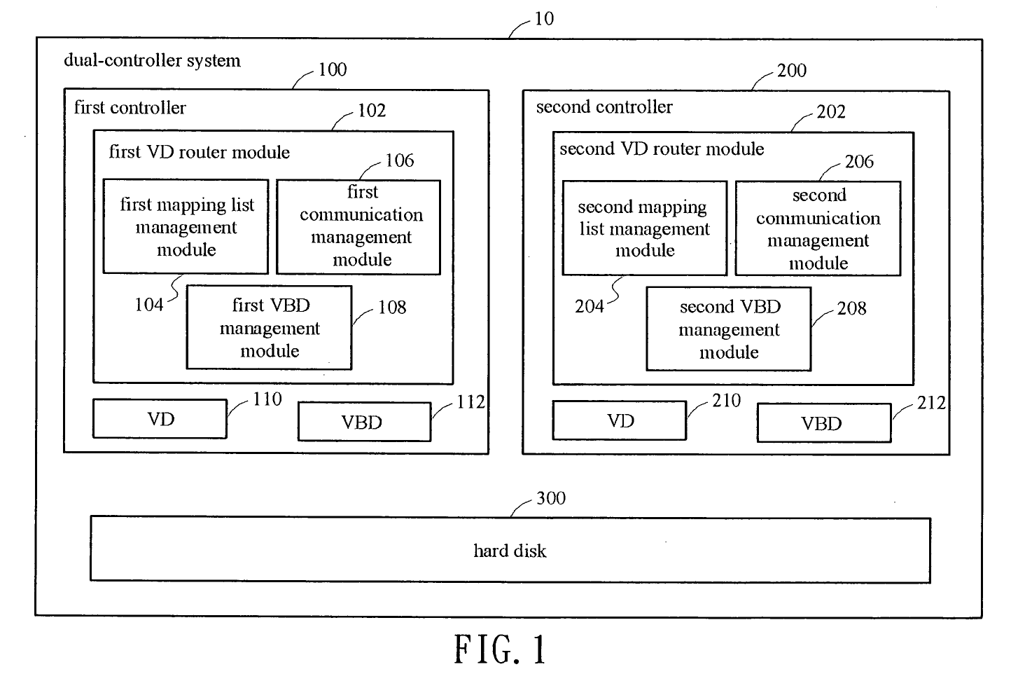

Referring to FIG. 1, a system block diagram of the structure of a VD access system of the present invention is shown. The VD access system is applied to a dual-controller system 10. A first controller 100 and a second controller 200 of the dual-controller system 10 both can operate a hard disk 300, so as to establish a VD therein. As the VDs are invisible to the sub-system of the other controller, compared with the dual-controller system of the conventional art, the present invention adds a new functional module, i.e. a VD router module. Here, the VD router module is used to determine which controller sub-system the VD to be accessed by an application is in, and to select a suitable path to transmit the data of the application to an object VD or to obtain and return the data required by the application from the object VD to the application, so as to improve services of data orientation and transmission for the applications and VDs in different controllers, thereby fulfilling the overall access of the VD in each sub-system of the dual-controller system 10.

As shown in FIG. 1, the first controller 100 and the second controller 200 of the dual-controller system 10 respectively include a first VD router module 102 and a second VD router module 202. The modules included in each VD router module are illustrated in detail below.

Seen from FIG. 1, the first VD router module 102 includes a first VBD management module 108, a first mapping list management module 104, and a first communication management module 106. The first VBD management module 108 is mainly used to establish a VBD and process a read/write request to the VBD, i.e. to establish a mapped VBD 112 corresponding to an access request VD 210 of the second controller 200 in the first controller 100. The first mapping list management module 104 is mainly used to maintain and manage the mapping relation of the VBD and the VD in the first controller 100. The first communication management module 106 is responsible for the communication between the external and the first VD router module 102, the internal scheduling of the first VD router module 102, and the data transmission between the first controller 100 and the second controller 200, and so on. The specific functions and principles of each module are illustrated in detail below.

Similarly, the second VD router module 202 of the second controller 200 also includes a second VBD management module 208, a second mapping list management module 204, and a second communication management module 206, which respectively have the function and structure similar to the corresponding modules of the first VBD management module 108, and thus will not be described herein again.

It is known from the system structural view of FIG. 1, the first VD router module 102 and the second VD router module 202 are respectively disposed above the VD in the system, so as to avoid the application from directly accessing the VD, such that the corresponding VD router module manages the mapped VBD of the VD, and processes operation requests such as read and write from the application to the VBD.

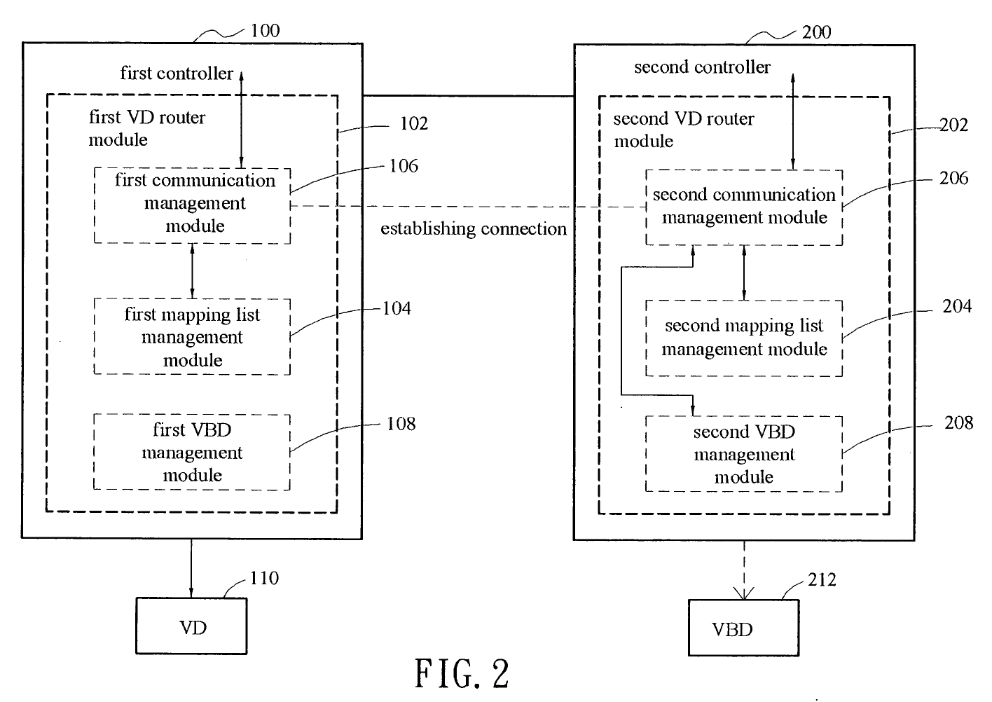

The illustration of the establishment of the VD, the VBD, and the mapping relation thereof is given below with reference to FIG. 2. FIG. 2 is a diagram of the operating principle of the establishment of the mapped VBD of the VD access system of the present invention. As the function of the second VBD management module 208 is similar to that of the first VBD management module 108, in this embodiment, the establishment of the VBD of the dual-controller of the present invention is illustrated with the establishment of the mapping of the VBD of a VD 110.

In this embodiment, after the first controller 100 operates the hard disk 300 to establish the VD 110, the corresponding information is sent to the first VD router module 102. The first communication management module 106 receives the establishment information and informs the first mapping list management module 104. The first mapping list management module 104 is used to establish a first corresponding relation list of the VD and the mapped VBD thereof. Therefore, the first mapping list management module 104 adds an item corresponding to the VD 110 into the first mapping list. The structures constituting each item of the mapping list mainly include: a) a VD identifier (VD_ID), used to identify the VD in a one-to-one mapping relation; (b) a VBD identifier (VBD_ID), used to identify the VBD in a one-to-one mapping relation; (c) a flag, used to identify which controller sub-system the VD in a one-to-one mapping relation is in, for example, 1 represents the local controller, and 2 represents the remote controller.

The VD_ID is unique in the whole dual-control system 10. That is, if a VD with a VD_ID of VD001 exists in the first controller 100, a VD with a VD_ID of VD001 will not exist in the second controller 200. The VBD_ID does not have the limitation of uniqueness.

In this embodiment, the first mapping list management module 104 sets the flag of an item corresponding to the VD 110 is 1, indicating that the VDE 110 is located in the local first controller 100. Then, an arbitrary algorithm is used to randomly obtain a VBD_ID as the ID of the mapped VBD 212 of the VDE 110, and the mapping relation item is saved. The selection algorithm of the VBD_ID is, for example, an ID pool is established, and each time an ID is randomly selected from the pool and returned after being used; or, an ID queue is established, and each time an ID is selected from the queue and put to the end of the queue after being used, and so on. Various conventional schemes can be employed here, which is not limited by the present invention and will not be described herein again. The first mapping list management module 104 informs the first communication management module 106 after finishing the above operations, and sends the item to the first communication management module 106.

The first communication management module 106 provides an exclusive transmission channel for the VD 110 with the VD_ID thereof as the unique identity for transmitting data, waits for the response of the second communication management module 206 of the second controller 200, and then returns the ready information and the item of VD 110 added in the first mapping list to the first controller 100. On receiving the returned information, the first controller 100 transmits the information on the establishment of the VDI 110 to the second controller 200.

In the second controller 200, the second communication management module 206 receives the information and informs the second mapping list module 204, so as to add the item of the VD 110 into the established second mapping list, and meanwhile save the item after setting the flag of the item as 2. Afterward, the second communication management module 206 informs the second VBD management module 208 to establish the mapped VBD 212 corresponding to the VD 110 and set the ID of the VBD 212. Here, the second communication management module 206 responds to the exclusive transmission channel provided by the first communication management module 106 for the VD 110, and finishes the establishment of the exclusive transmission channel.

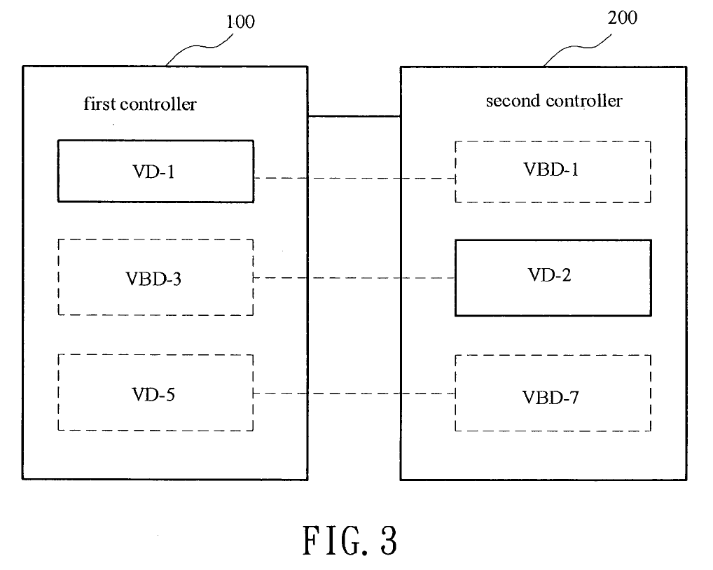

In this manner, the establishment of the VD and the mapped VBD thereof is finished, and the mapping relation is saved in the mapping list. The VBD 212 becomes a mapping of the VD in the sub-system of the second controller 200. The establishment of the mapped VBDs of other VDs of the first controller 100 in the second controller 200 or the establishment of the mapped VBD of the VD of the second controller 200 in the first controller 100 can be achieved by the process described above, and the details will not be described herein again. For example, the corresponding relations of the VDs and the mapped VBDs thereof in the first controller 100 and the second controller 200 are as shown in FIG. 3.

Whenever a new VD is established in the dual-control system 10, the mapping list management modules 104 and 204 on both ends may add a new item in the maintained mapping relation list, respectively. Similarly, whenever a VD is deleted from the dual-control system 10, the mapping list management modules 104 and 204 on both ends may also delete the corresponding item in the maintained mapping relation list, respectively. The flow of the deletion operation is similar to that of the establishment operation. First, the device node of the VBD is deleted, the exclusive transmission channel is closed, the corresponding item in the mapping list is deleted, then the VD is deleted, and all the used resources are released in the deletion process, which may not be described herein again. For each existing mapping relation, the mapping lists in the two controller sub-systems 100, 200 respectively have an item, in which only the flags of the corresponding items are different, i.e. one represents the local controller, the other represents the remote controller, and other IDs are completely identical.

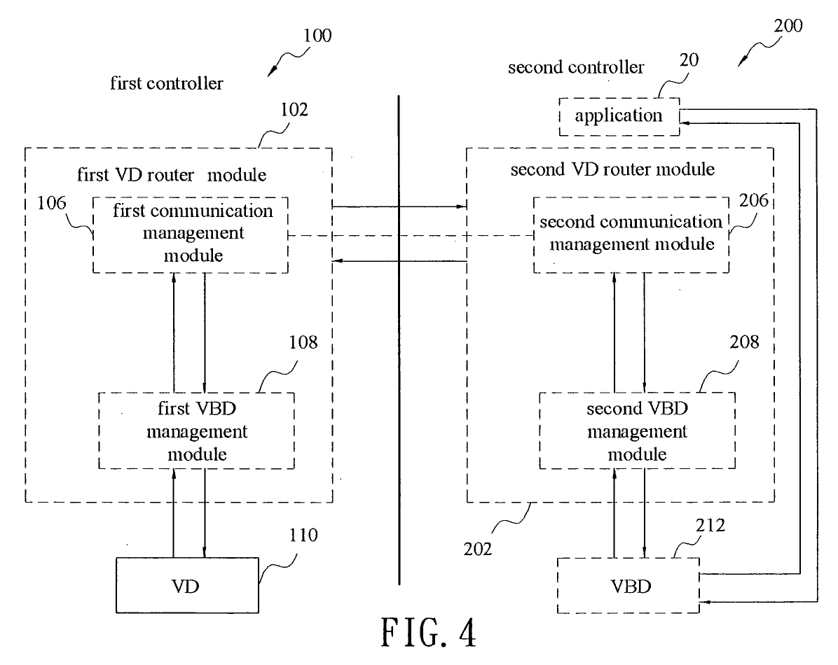

The principle of accessing the VD of an arbitrary controller sub-system in the dual-control system by the application is illustrated with FIG. 4. FIG. 4 is an embodiment of a diagram of the operating principle on the VD access of the VD access system according to the present invention. In this embodiment, the process of the application 20 accessing the VD 110 in the first controller 100 through the second controller 200 is illustrated. However, it should be pointed out that this embodiment is only used to clarify the principle of the VD access of an arbitrary controller sub-system in the dual-control system of the present invention, and the present invention is not limited to this embodiment.

As shown in FIG. 4, when the application 20 of a client issues a request of accessing the VD 110 to the second controller 200, the second communication management module 206 of the second VD router module 202 receives the access request, and forwards the request to the second mapping list management module 204. The second mapping list management module 204 queries the second mapping relation list according to the request, and checks the VD_ID of each item in the map list, so as to determine whether an item the same as the requested VD_ID exists or not. If no, a request failure is returned; otherwise, the flag of the item is checked, in which if the flag indicates that the requested VD is located in the local controller, the device ID of the VD is directly returned to the second communication management module 206, so as to be returned to the application 20 for operation, and if the flag indicates that the requested VD is located in the remote controller, the second mapping list management module 204 returns the device ID of the VBD corresponding to the VBD_ID in the item to the second communication management module 206, so as to be returned to the application 20.

According to this embodiment, as the accessed VD 110 is remote, the application 20 receives the device ID of the VBD 212. The VBD 212 is only a virtual mapping, not an actual device existing in the local controller, so the process of the access operation request from the application 20 to the VD 110 is described as follow.

When the application 20 performs an operation such as read and write on the mapped VBD 212 of the VD 110, the second VBD management module 208 collects the operation request from the buffer area of the VBD 212, and encapsulates the collected operation request into a data packet to be sent to the second communication management module 206 for processing. The second communication management module 206 sends the data packet to the first communication management module 106 of the first controller 100 via the established data transmission channel. The first communication management module 106 receives and sends the data packet to the first VBD management module 108. The first VBD management module 108 decapsulates the data packet, and the operation is applied to the actual VD 110. The VD 110 returns the operation result to the first VBD management module 108, and reencapsulates the operation result into a data packet. Then, the first communication management module 106 and the second communication management module 206 send the operation result data packet to the second VBD management module 208. The second VBD management module 208 decapsulates and sends the data packet back to the buffer area of the VBD 212. Finally, the application 20 reads the operation result of the VD 110 from the buffer area of the VBD 212, thereby fulfilling the access request from the application 20 to the VD of the remote controller.

If the application 20 accesses the local end, i.e. the VD in the second controller 200, the ID of the actual VD is received, and the actual device can be directly operated. Here, no matter for VD or VBD, the second VD router module 202 may return a device ID to the application 20 for operation. The application 20 only operates a device ID, and though it is not known whether the device ID represents a VBD of the local VD or the remote VD, the VD is overall for the application 20.

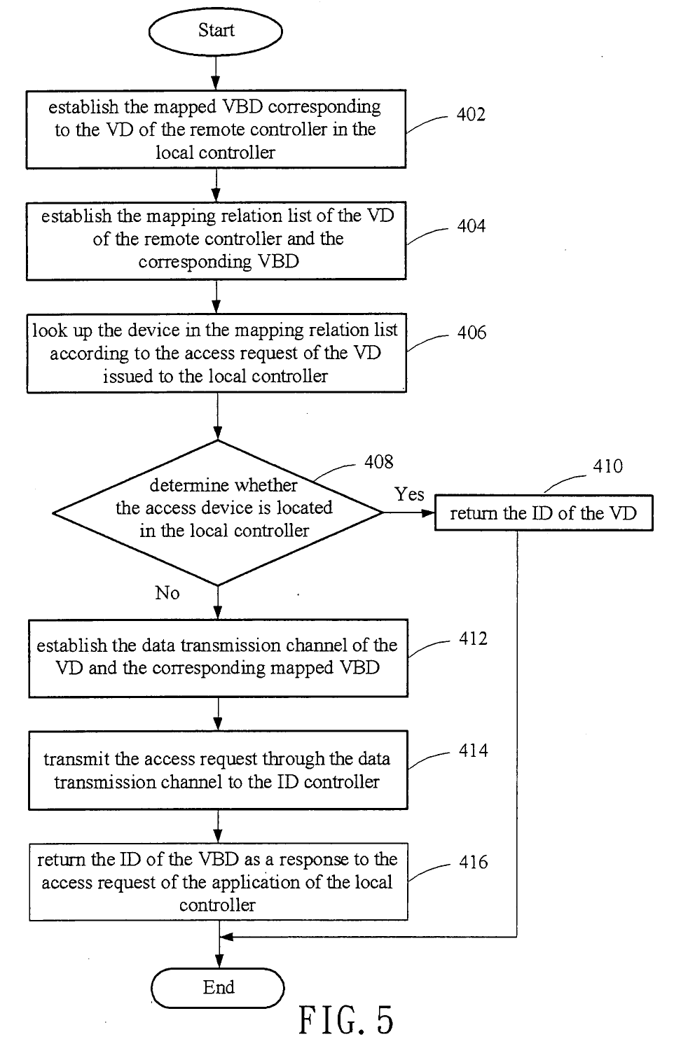

A detailed description of the method of accessing the VD according to the present invention is given below with reference to FIGS. 5, 6, and 7.

Referring to FIG. 5, a flow chart of the method of accessing the VD of the present invention is shown. As shown in the figure, first, in each controller sub-system of the dual-controller system, the mapped VBD corresponding to the VD of the local/remote controller is established in the remote/local controller (Step 402). Then, according to the established VBD, the mapping relation list of the VD in each controller and the corresponding VBD is established (Step 404). The structure of the mapping relation list includes a VD_ID, a VBD_ID, and a flag. The VD_ID is used to identify the VD in the mapping relation list, the VBD_ID is used to identity the mapped VBD in the mapping relation list, and the flag is used to identify the position of the VD, i.e. whether the VD is located in the local controller or in the remote controller.

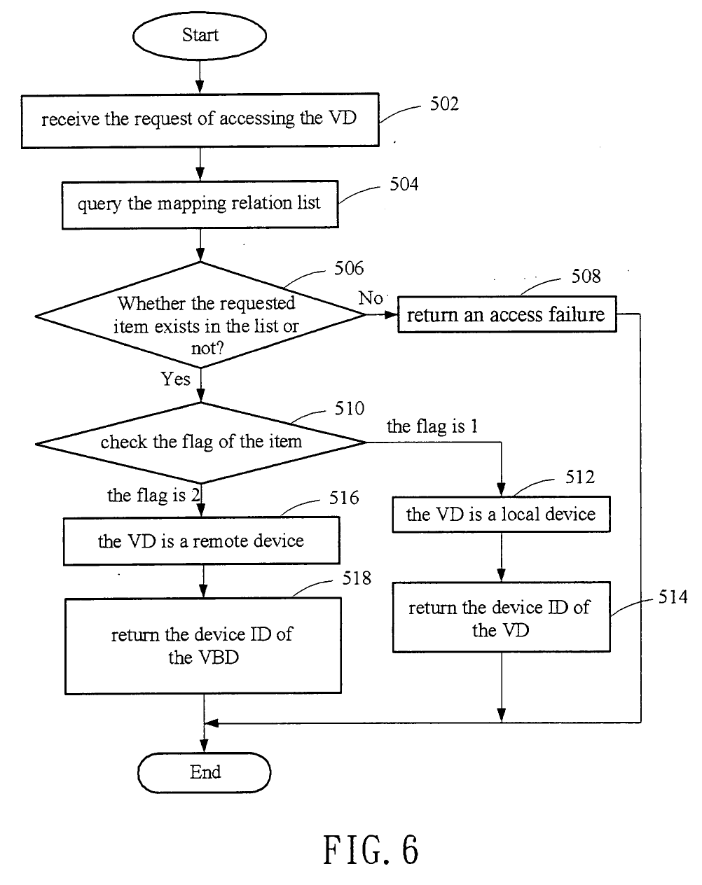

When the application of the client issues an access request of the VD to a local controller, according to the access request, the device ID of the VD is looked up in the established mapping relation list (Step 406). Then, according to the ID, it is determined whether the access VD exists in the current controller (Step 408). The above determination step is described in detail in FIG. 6. As shown in FIG. 6, the request of accessing the VD is received from the application (Step 502), and the mapping relation list is queried (Step 504). First, according to the ID of the requested VD, it is determined that whether the mapping relation list has the requested item of the VD (Step 506). If the item does not exist, a request failure is returned (Step 508); otherwise, the flag of the item is checked, in which it is set that the flag of 1 indicates that the VD is a local device, the flag of 2 indicates the remote device, and apparently the setting of the flag is not limited to the above manner. According to this embodiment, it is determined through the flag if the disk is located in the local controller (Step 512), the device ID of the VD is returned (Step 514); otherwise, if it is determined that the VD is a remote device (Step 516), the device ID of the VBD is returned (Step 518).

According to the above position determination step of the VD, if the VD is located in the local controller, the VD_ID is returned, and the application directly operates the VD (Step 410); otherwise, it indicates that the VD to be accessed is located in the remote controller, and the data transmission channel of the VD and the corresponding mapped VBD in the current controller is established (Step 412). The data transmission channel is used to transmit the access request to the remote controller (Step 414). Next, the ID of the VBD is returned as a response to the access request of the application of the local controller (Step 416).

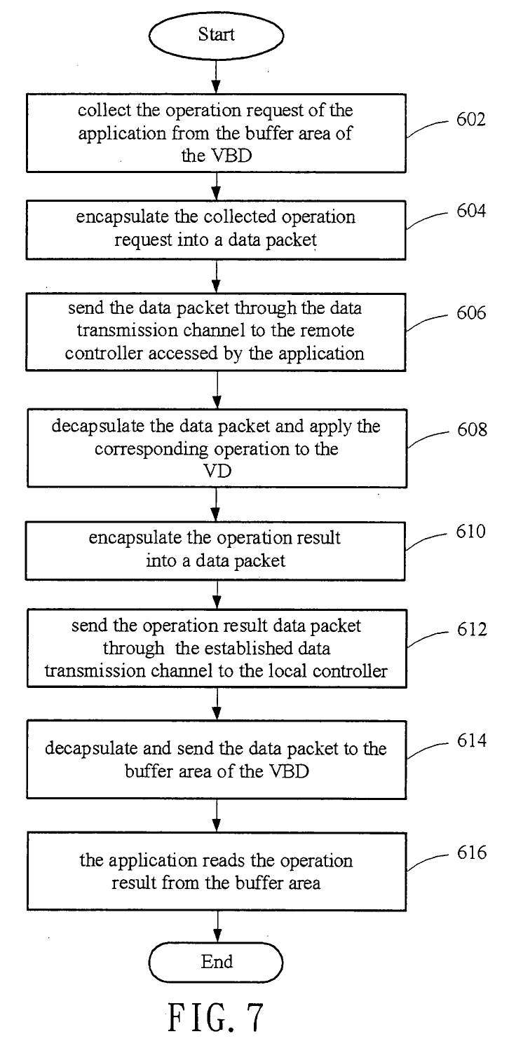

The data transmission step between the remote controller and the local controller for accessing the remote VD is described in FIG. 7, which is a flow chart of the process of the data transmission of the mapped VBD in the method of accessing the VD according to the present invention. As shown in the figure, when the VD accessed by the application through the local controller is located in the remote controller, the operation request of the application is first collected from the buffer area of the mapped VBD of the VD (Step 602), and then the collected operation request is encapsulated into a data packet (Step 604). Next, the encapsulated data packet is sent through the established data transmission channel to the remote controller accessed by the application (Step 606). The remote controller decapsulates the received data packet, and applies the corresponding operation to the accessed VD (Step 608). Afterward, the operation result returned after the VD operation is encapsulated into a data packet (Step 610), and the operation result data packet is sent through the data transmission channel to the local controller (Step 612). The data packet is decapsulated in the local controller and is sent to the buffer area of the corresponding VBD (Step 614), such that the application reads the operation result from the buffer area, thereby fulfilling the access to the VD (Step 616).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A virtual disk (VD) router system, applied to a dual-control system having a first controller and a second controller, wherein the VD router system is disposed in the first controller and comprises:
a virtual block device (VBD) management module, for establishing a mapped VBD corresponding to a VD of the second controller in the first controller, and processing an access request of the VD issued to the first controller;
a mapping list management module, for establishing a mapping relation list of the VD of the second controller and a corresponding VBD thereof, and looking up the VD and the corresponding mapped VBD in the mapping relation list according to the access request of the VD issued to the first controller; and
a communication management module, for establishing a data transmission channel of the VD of the second controller and the corresponding mapped VBD, so as to transmit the access request of the VD to the second controller, and to receive a response from the second controller to the access request of the VD.

2. The VD router system as claimed in claim 1, wherein structure of the mapping relation list comprises:
a VD identifier (VD_ID), for identifying the VD in the mapping relation list;
a VBD identifier (VBD_ID), for identifying the mapped VBD corresponding to the VD in the mapping relation list; and
a flag, for identifying type of controller system the VD is in.

3. The VD router system as claimed in claim 2, wherein the mapping list management module returns a VD_ID or a VBD_ID to the communication management module according to a look-up result of the mapping relation list.

4. The VD router system as claimed in claim 3, wherein after the communication management module receives the VBD_ID, the VBD management module collects an operation request of the access request from a buffer area of the VBD corresponding to the VD_ID identified by the VBD_ID, encapsulates the collected operation request into a data packet, and sends the data packet through the data transmission channel to the remote second controller.

5. The VD router system as claimed in claim 4, wherein after the communication management module receives the response of the second controller to the access request of the VD, the VBD management module sends the response of the access request of the VD to the buffer area of the mapped VBD corresponding to the VD, so as to read the operation result from the buffer area of the mapped VBD.

6. A virtual disk (VD) access system, applied to a dual-control system having a first controller and a second controller, comprising:
a first VD router, disposed in the first controller, for determining a position of a VD issuing an access request to the first controller, so as to select a transmission path to transmit the access request to the VD and to transmit a response data to the access request from the VD; and
a second VD router, disposed in the second controller, for determining a position of a VD issuing an access request to the second controller, so as to select a transmission path to transmit the access request to the VD and to transmit a response data to the access request from the VD.

7. The VD access system as claimed in claim 6, wherein the first VD router comprises:
a first VBD management module, for establishing a mapped virtual block device (VBD) corresponding to the VD of the second controller in the first controller;
a first mapping list management module, for establishing a mapping relation list of the VD of the second controller and the corresponding VBD, and looking up the VD and the corresponding mapped VBD in the mapping relation list according to the access request of the VD issued to the first controller; and
a first communication management module, for establishing a data transmission channel of the VD of the second controller and the corresponding mapped VBD.

8. The VD access system as claimed in claim 6, wherein the second VD router comprises:
a second VBD management module, for establishing a mapped VBD corresponding to the VD of the first controller in the second controller;
a second mapping list management module, for establishing a mapping relation list of the VD of the second controller and the corresponding VBD, and looking up the VD and the corresponding mapped VBD in the mapping relation list according to the access request of the VD issued to the second controller; and
a second communication management module, for establishing a data transmission channel of the VD of the first controller and the corresponding mapped VBD.

9. The VD access system as claimed in claim 7, wherein the first communication management module/the second communication management module uses the data transmission channel to transmit the access request of the VD to the second controller/the first controller, and to receive the response data of the second controller/the first controller to the access request of the VD.

10. The VD access system as claimed in claim 8, wherein the first communication management module/the second communication management module uses the data transmission channel to transmit the access request of the VD to the second controller/the first controller, and to receive the response of the second controller/the first controller to the access request of the VD.

11. A method of accessing a virtual disk (VD), applied to a dual-control system having a first controller and a second controller, comprising:
establishing a mapped virtual block device (VBD) corresponding to a VD of the second controller and/or the first controller in the first controller and/or the second controller;
establishing a mapped VBD relation list of the VD of the second controller and/or the first controller and the corresponding VBD;
looking up the VD and the corresponding mapped VBD in the mapping relation list, according to an access request of the VD issued to the first controller/the second controller, so as to determine a position of the VD; and
when the VD issuing the access request to the first controller/the second controller is located in the second controller/the first controller, establishing a data transmission channel of the VD and the corresponding mapped VBD, so as to transmit/receive the access request/a response data of the VD.

12. The method of accessing the VD as claimed in claim 11, wherein structure of the mapping relation list comprises:
a VD identifier (VD_ID), for identifying the VD in the mapping relation list;
a VBD identifier (VBD_ID), for identifying the mapped VBD in the mapping relation list; and
a flag, for identifying the position of the VD.

13. The method of accessing the VD as claimed in claim 12, wherein when the flag identifies that the VD is located at the first controller/the local second controller in local, the VD_ID of the VD is returned as a response to the access request of the VD.

14. The method of accessing the VD as claimed in claim 12, wherein when the flag identifies that the VD is located at the first controller/the second controller in remote, the VBD_ID of the corresponding mapped VBD of the VD is returned as a response to the access request of the VD.

15. The method of accessing the VD as claimed in claim 14, further comprising:
using the data transmission channel to transmit the access request of the VD to the first controller/the second controller in remote; and
using the data transmission channel to transmit the response data of the first controller/the second controller in remote to the access request of the VD.

16. The method of accessing the VD as claimed in claim 15, wherein the step of transmitting the access request of the VD to the first controller/the second controller in remote further comprises:
collecting an operation request of the access request from a buffer area of the mapped VBD corresponding to the VD;
encapsulating the collected operation request into a data packet; and
sending the data packet through the data transmission channel to the first controller/the second controller in remote.

17. The method of accessing the VD as claimed in claim 16, wherein the step of transmitting the response data of the first controller/the second controller in remote to the access request of the VD further comprises:
decapsulating the data packet and applying the operation request to the VD;
encapsulating an operation result of the VD into a data packet;
sending the operation result data packet through the data transmission channel to the second controller/the first controller in local;
decapsulating and sending the operating data packet to the buffer area of the corresponding mapped VBD of the VD; and
reading the operation result from the buffer area of the mapped VBD.
